(19) United States
(12) Patent Application Publication
(10) Pub. No.: US 2014/0204275 A1
(43) Pub. Date: Jul. 24, 2014

(54) ILLUMINATION DEVICE, DISPLAY DEVICE, AND TELEVISION RECEPTION DEVICE

(71) Applicant: Takaharu Shimizu, Osaka (JP)

(72) Inventor: Takaharu Shimizu, Osaka (JP)

(73) Assignee: SHARP KABUSHIKI KAISHA, Osaka (JP)

(21) Appl. No.: 14/237,520

(22) PCT Filed: Aug. 3, 2012
(86) PCT No.: PCT/JP2012/069811

§ 371 Date: Feb. 6, 2014

(30) Foreign Application Priority Data
Aug. 12, 2011 (JP) 2011-176766

(51) Int. Cl. F21V 8/00

(52) U.S. Cl. CPC G02B 6/0031
USPC 348/725; 362/609; 349/65

(57) ABSTRACT

A backlight device (24) of the present invention includes: a chassis (22) having at least a bottom plate (22a) that is rectangular in a plan view; a light guide plate (20) that has light-receiving faces (20a), which are side faces, and a rear surface that faces the surface side of the bottom plate (22a); LED light sources (28) that are arranged on the surface side of the bottom plate (22a) and that face the respective light-receiving faces (20a); protruding parts that have a protruding shape and spacer parts positioned on the surface side of the bottom plate (22a), facing the light guide plate (20) side; and a reflective sheet (26) that is arranged between the light guide plate (20) and bottom plate (22a). A portion of the end edge of the reflective sheet (26) is a free section (26b) that allows movement in the plate surface direction of the light guide plate (20), and the other end edges are restricted sections (26a) that restrict movement in the plate surface direction of the light guide plate (20) by being held between the respective spacer members and the light guide plate (20).

### TECHNICAL FIELD

The present invention relates to an illumination device, a display device, and a television receiver.

### BACKGROUND ART

In recent years, flat panel display devices that use flat panel display elements such as liquid crystal panels and plasma display panels are increasingly used as display elements for image display devices such as television receivers instead of conventional cathode-ray tube displays, allowing image display devices to be made thinner. Liquid crystal panels used in liquid crystal display devices do not emit light on their own, and therefore, it is necessary to provide a separate backlight device as an illumination device. A known example of such a backlight device is an edge-lit type backlight device in which a light-receiving face is provided on as a side face of a light guide plate, and a light source such as an LED is provided facing the side face of the light guide plate.

In an edge-lit backlight device, there are cases in which a reflective sheet is provided for reflecting light that has leaked from the light guide plate back towards the light guide plate. This reflective sheet is arranged between a chassis, which is the casing, and a bottom plate. Such a reflective sheet sometimes expands or contracts due to heat generated by the light source, and this may cause wrinkling or the like on the reflective sheet. If the reflective sheet becomes wrinkled, the gap between the light guide plate and the reflective sheet will change in portions, which may cause differences in contrast of the light on the light-exiting surface of the light guide plate and lead to uneven brightness on the display surface of the backlight device.

An edge-lit backlight device that is capable of eliminating uneven brightness on the display surface thereof by effectively dissipating heat generated by the light sources is disclosed in Patent Document 1. This backlight device is provided with a compound reflective film that efficiently dissipates heat generated by the light sources. In this backlight device, the compound reflective film alleviates differences in temperature inside the backlight device, making the reflective sheet less susceptible to wrinkling or the like, and thereby preventing or suppressing uneven brightness on the display surface.

### RELATED ART DOCUMENT

### Patent Document

Patent Document 1: Japanese Patent Application Laid-Open Publication No. 2009-210731

### Problems to be Solved by the Invention

In the backlight device in Patent Document 1, however, it is necessary to use a special compound reflective film with a heat dissipating effect in order to eliminate uneven brightness on the display surface, resulting in a significant increase in manufacturing steps and an increase in manufacturing costs.

### SUMMARY OF THE INVENTION

The technology disclosed in the present specification was made in view of the above-mentioned problems. The present invention aims at providing a technology that can prevent or suppress uneven brightness on a display surface by using a simple configuration.

### Means for Solving the Problems

The technology disclosed in the present specification relates to an illumination device including a chassis having at least a plate-shaped portion that is rectangular in a plan view; a light guide plate that has a light-receiving surface as a side face and that has a plate surface opposing a surface of the plate-shaped portion; a light source that is arranged on the surface of the plate-shaped portion and that faces the light-receiving surface; a protruding part that is located on the surface of the plate-shaped portion and that protrudes towards the light guide plate; and a reflective sheet that is arranged between the light guide plate and the plate-shaped portion and that has a portion of an end edge as a free section that allows movement in a plate surface direction of the light guide plate and that has another end edge as a restricted section that restricts movement in the plate surface direction of the light guide plate by being held between the protruding part and the light guide plate.

With the above-mentioned illumination device, wrinkling in the reflective sheet that are caused by the thermal expansion and contraction thereof can be eliminated at the free section while the reflective sheet is held in place at the restricted section. As a result, uneven brightness on the display surface can be eliminated or suppressed with a simple configuration.

The protruding part may include a protruding section where a portion of the plate-shaped portion protrudes towards the light guide plate.

With this configuration, a restricted section can be achieved in which a portion of the reflective sheet is held between a portion of the plate-shaped portion and the light guide plate.

The protruding part may include a spacer member arranged between the plate-shaped portion and the light guide plate.

With this configuration, a holding part can be achieved in which a portion of the reflective sheet is held between the spacer member and the light guide plate.

A thickness of the spacer member may be equal to a thickness of the reflective sheet.

With this configuration, the height of the gap between the plate-shaped portion and the light guide plate created by the spacer member is equal to the thickness of the reflective sheet; therefore, a configuration can be achieved in which a portion of the reflective sheet is held between a portion of the plate-shaped portion and the light guide plate at the free section. In this case, in the restricted section a portion of the reflective sheet is directly held between the spacer member and the light guide plate, and thus, the force that holds the reflective sheet in place is weaker at the free section than the restricted section, allowing movement in the plate surface direction of the light guide plate at the free section.

The present technology may further include an optical member that is rectangular in a plan view and that is arranged above another plate surface of the light guide plate; and a frame member arranged above an end edge of the optical member, wherein an abutting face between the frame member and the optical member overlaps an abutting face between the protruding part and the reflective sheet of the restricted section in a thickness direction of the light guide plate and does not overlap an abutting face between the protruding part and the reflective sheet of the free section in the thickness direction of the light guide plate.

With this configuration, the restricted section of the reflective sheet is indirectly held between the protruding part by the frame member through the light guide plate, whereas the free section of the reflective sheet is not indirectly held by the frame member and is held between the protruding part only by the light guide plate. Therefore, the force that holds the reflective sheet in place is weaker at the free section than the restricted section, allowing movement in the plate surface direction of the light guide plate at the free section.

The plate-shaped portion may be rectangular, the reflective sheet may be rectangular and a long side thereof may be arranged along a long side of the plate-shaped portion, and the free section may be provided on an end edge of the reflective sheet that is arranged on one long side of the plate-shaped portion.

If the reflective sheet is rectangular, the long sides thereof are more susceptible than the short sides to being warped during thermal expansion and contraction. With the above configuration, the free section is provided on the long side of the reflective sheet, thereby making it possible to effectively eliminate thermal expansion and contraction of the reflective sheet at the free section.

The present technology may further include a light source substrate having a plurality of the light sources arranged on a plate surface thereof, wherein the light source substrate is arranged along both long side directions of the plate-shaped portion.

Thermal expansion and contraction of the reflective sheet is more susceptible to occurring the closer to the light sources the location is. With the above configuration, the free section is provided on the light source substrate side of the reflective sheet where thermal expansion and contraction are likely to occur; therefore, the thermal expansion and contraction of the reflective sheet can be effectively eliminated while achieving a configuration in which the light source substrate is arranged on both long sides of the plate-shaped portion.

The restricted section and the free section may be arranged together on a side of the reflective sheet.

With this configuration, in the area where the restricted section and free section are arranged together, a portion of the reflective sheet is held in place by the restricted section, while the force that holds the reflective sheet in place is weaker than in an area where only the restricted section is present; this results in being able to eliminate thermal expansion and contraction of the reflective sheet while fixing the reflective sheet at the area where the restricted section and free section are arranged together.

The techniques disclosed in the present specification can be expressed as a display device that includes a display panel that displays images using light from the above-mentioned illumination device. Also, a display device that uses a liquid crystal panel that uses liquid crystal as the display panel is novel and useful. A television receiver that includes the above-mentioned display device is also novel and useful.

### Effects of the Invention

According to the present invention, a technology that can prevent or suppress uneven brightness on a display surface can be provided by using a simple configuration.

### BRIEF DESCRIPTION OF THE DRAWINGS

FIG. 1 is an exploded perspective view of a television receiver TV according to Embodiment 1.

FIG. 2 is an exploded perspective view of a liquid crystal display device 10.

FIG. 3 is a plan view of a backlight device 24 seen from the front.

FIG. 4 is a cross-sectional view of the liquid crystal display device 10 in a restricted section 26a of a reflective sheet 26.

FIG. 5 is a cross-sectional view of the liquid crystal display device 10 in a free section 26b of the reflective sheet 26.

FIG. 6 is a cross-sectional view of a liquid crystal display device 110 in a free section 126b of a reflective sheet 126 in a modification example of Embodiment 1.

FIG. 7 is a cross-sectional view of a liquid crystal display device 210 in a restricted section 226a of a reflective sheet 226 in Embodiment 2.

FIG. 8 is a cross-sectional view of the liquid crystal display device 210 in a free section 226b of the reflective sheet 226 in Embodiment 2.

FIG. 9 is a cross-sectional view of a liquid crystal display device 310 in a restricted section 326a of a reflective sheet 326 in Embodiment 3.

FIG. 10 is a cross-sectional view of the liquid crystal display device 310 in a free section 326b of the reflective sheet 326 in Embodiment 3.

FIG. 11 is a cross-sectional view of a liquid crystal display device 410 in a restricted section 426a of a reflective sheet 426 in Embodiment 4.

FIG. 12 is a cross-sectional view of the liquid crystal display device 410 in a free section 426b of the reflective sheet 426 in Embodiment 4.

FIG. 13 is a plan view of a backlight device 524 seen from the front according to Embodiment 5.

FIG. 14 is a plan view of a backlight device 624 seen from the front according to Embodiment 6.

FIG. 15 is a plan view of a backlight device 724 seen from the front according to

Embodiment 7.

### DETAILED DESCRIPTION OF EMBODIMENTS

### Embodiment 1

Embodiment 1 will be described with reference to the drawings. Each of the drawings indicates an X axis, a Y axis, and a Z axis in a portion of the drawings, and each of the axes indicates the same direction for the respective drawings. The Y axis direction corresponds to the vertical direction and the X axis direction corresponds to the horizontal direction. Unless otherwise noted, “up” and “down” in the description is based on the vertical direction.

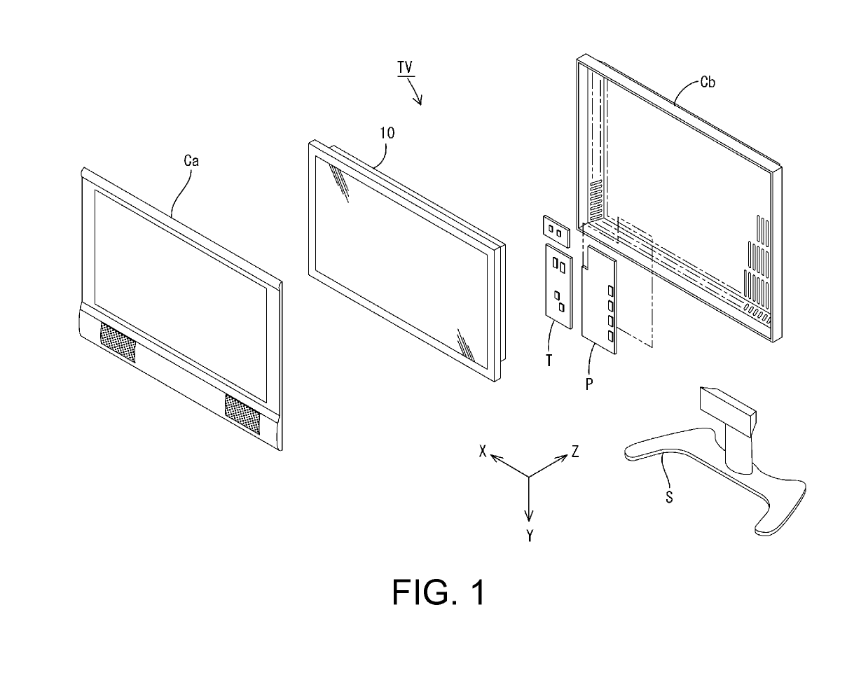

FIG. 1 is an exploded perspective view of a television receiver TV according to Embodiment 1. The television receiver TV includes a liquid crystal display device 10, front and rear cabinets Ca and Cb that house the display device D therebetween, a power source P, a tuner T, and a stand S.

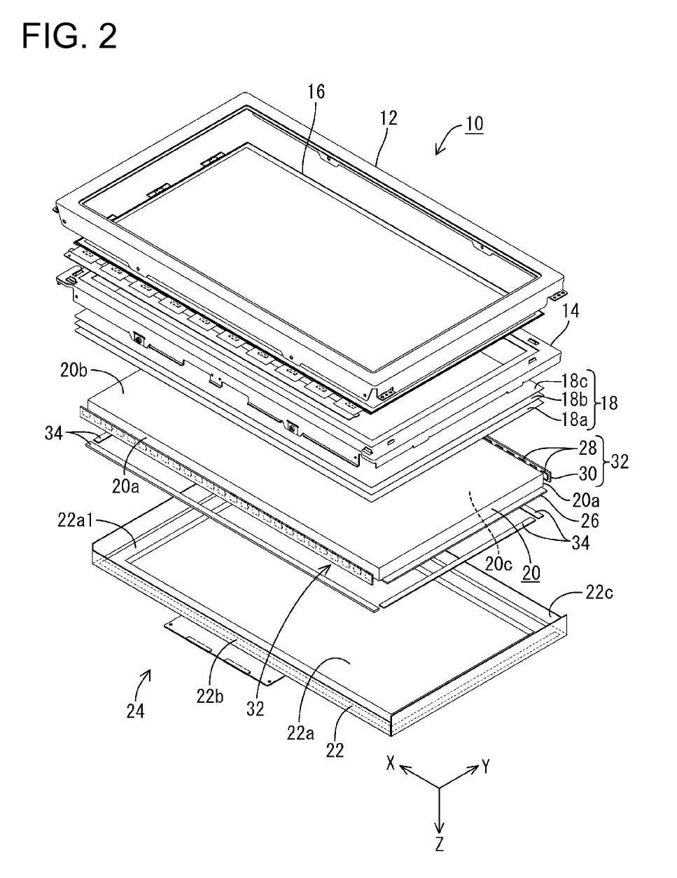

FIG. 2 is an exploded perspective view of the liquid crystal display device 10. The upper side of FIG. 2 is the front side, and the lower side is the rear side. As shown in FIG. 2, the liquid crystal display device 10 is longer in the horizontal direction as a whole, includes a liquid crystal panel 16, which is a display panel, and a backlight device 24, which is an external light source, and is held together integrally with a frame-shaped bezel 12 or the like.

Next, the liquid crystal panel 16 will be described. In the liquid crystal panel 16, a pair of transparent (having a high light transmission) glass substrates are bonded together with a prescribed gap therebetween, and a liquid crystal layer (not shown) is sealed between the glass substrates. One of the glass substrates has switching elements (TFTs, for example) that are respectively connected by mutually intersecting source wiring lines and gate wiring lines, a pixel electrode connected to each of these switching elements, an alignment film, and the like. The other glass substrate has color filters with colored portions such as R (red), G (green), and B (blue) arranged in prescribed arrays, an opposite electrode, an alignment film, and the like. Of these, the source wiring lines, the gate wiring lines, the opposite electrode, and the like are supplied with image data and various control signals necessary in order to display images from a driver circuit substrate that is not shown in drawings. Polarizing plates (not shown) are disposed on the outside of the glass substrates.

Next, the backlight device 24 will be described. As shown in FIG. 2, the backlight device 24 includes a frame 14, an optical member 18, and a chassis 22. The frame 14 has a frame shape and is arranged along end sides of a surface (light-exiting surface 20b) of a light guide plate 20. The frame 14 supports the liquid crystal panel 16 along the inner edges. The optical member 18 is placed on the front side (the light-exiting surface 20b side) of the light guide plate 20. The chassis 22 has a substantially box shape that is open on the front side (light-exiting side/liquid crystal panel 16 side).

A pair of LED (light emitting diode) units 32 and 32, four spacers 34, a reflective sheet 26, and the light guide plate 20 are housed inside the chassis 22. The four spacers 34 are respectively arranged so as to be along both long directions and both short directions of the chassis 22, and have a flat plate-like shape. One of the spacers 34 arranged along one of side walls 22b in the long direction of the chassis 22 has a slightly greater thickness than the other three spacers 34. The spacers 34 will be described in detail later. A pair of the LED units 32 and 32 each extend in the long direction of the chassis 22 and each abut the inside of the long side walls 22b and 22c in the chassis 22. The pair of LED units 32 and 32 emit light towards a light-receiving face 20a of the light guide plate 20. The lengthwise direction side faces (light-receiving faces) 20a of the light guide plate 20 are disposed at positions facing the LED units 32 and 32, and guide light emitted from the LED units 32 towards the liquid crystal panel 16. The optical member 18 is placed on the front side of the light guide plate 20. In the backlight device 24 of the present embodiment, the light guide plate 20 and the optical member 18 are disposed directly below the liquid crystal panel 16, and the LED units 32, which are the light sources, are disposed on side edges of the light guide plate 20, this configuration being the so-called edge-lit type (side light type).

The chassis 22 is made of a metal such as an aluminum-type material, for example, and is constituted of a bottom plate 22a that is rectangular in a plan view, side walls 22b and 22c that rise from the outer edges of the respective long sides of the bottom plate 22a, and side walls that rise from the outer edges of the respective short sides of the bottom plate 22a. The space inside the chassis 22 between the LED units 32 and 32 is the housing space for the light guide plate 20. A frame-shaped protruding section 22a1 that protrudes towards the light guide plate 20 is disposed on the end edge areas of the surface of the bottom plate 22a. The top surface of the protruding section 22 is flat and it is possible to place the light guide plate 20 along the end edges thereof through the spacers 34. On the rear side of the bottom plate 22a, a power source circuit board (not shown) that supplies power to the LED units 32, and the like are attached.

The optical member 18 includes a diffusion sheet 18a, a lens sheet 18b, and a reflective polarizing plate 18c layered in this order from the light guide plate 20 side. The diffusion sheet 18a, the lens sheet 18b, and the reflective polarizing plate 18c function to convert the light emitted from the LED units 32 and transmitted through the light guide plate 20 into planar light. The liquid crystal panel 16 is disposed on the upper side of the reflective polarizing plate 18d, and the optical member 18 is disposed between the light guide plate 20 and the liquid crystal panel 16.

The LED unit 32 has a configuration in which the LED light sources 28, which emit white light, are aligned in a row on a rectangular LED substrate 30, which is made of resin. The face of the LED substrate 30 that is opposite to the face on which the LED light sources 28 are arranged abuts a heat dissipation plate 36. The LED light source 28 may have a configuration in which white light is emitted by having a blue light emitting element coated with a fluorescent material that has a light emitting peak in the yellow region. The LED light source 28 may alternatively have a configuration in which white light is emitted by having a blue light emitting element coated with fluorescent materials that have light emitting peaks in the green region and the red region, respectively. The LED light source 28 may also have a configuration in which white light is emitted by having a blue light emitting element coated with a fluorescent material that has a light emitting peak in the green region, and combining this with a red light emitting element. The LED light source 28 may also have a configuration in which white light is emitted by combining a blue light emitting element, a green light emitting element, and a red light emitting element. The LED light source 28 may also be a combination of an ultraviolet light emitting element with fluorescent materials. In particular, the LED light source 28 may have a configuration in which white light is emitted by having the ultraviolet light emitting element coated with fluorescent materials that have light emitting peaks in the blue, green, and red regions, respectively.

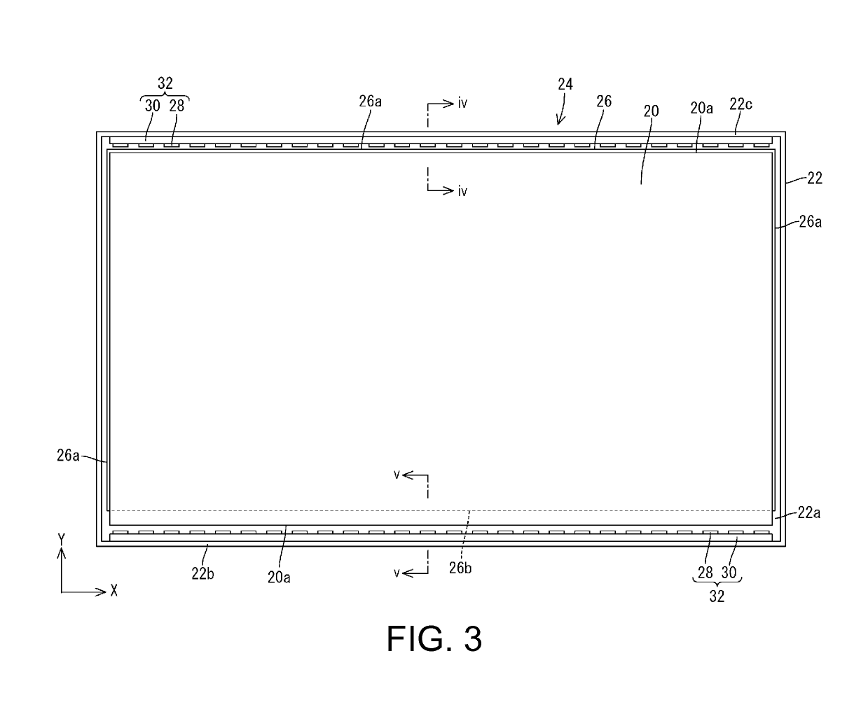

The light guide plate 20 is a rectangular plate-shaped member formed of a resin of acrylic or the like with a high transmission (high transparency), the light guide plate 20 abutting the reflective sheet 26 and being supported by the chassis 22. As shown in FIGS. 2 and 3, between the pair of LED units 32 and 32 the light guide plate 20 has the light-exiting surface 20b, which is the main plate surface of the light guide plate 20, facing the diffusion sheet 18a, and an opposite plate surface 20c, which is the plate surface opposite to the light-exiting surface 20b, facing the reflective sheet 26. By providing such a light guide plate 20, the light generated by the LED units 32 enters from the light-receiving face 20a of the light guide plate 20 and exits from the light-exiting surface 20b that faces the diffusion sheet 18a, thereby illuminating the liquid crystal panel 16 from the rear side thereof.

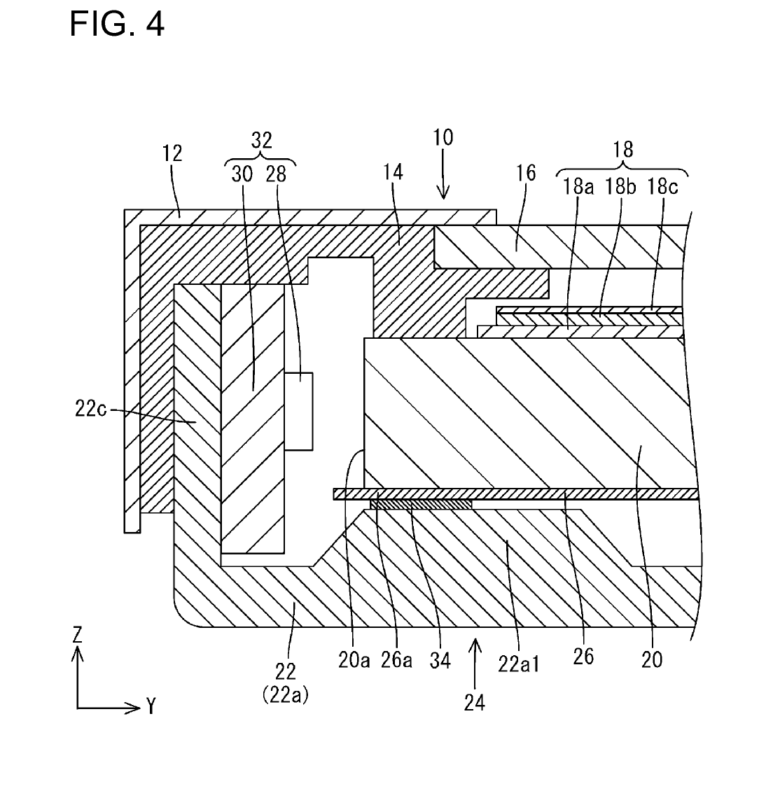

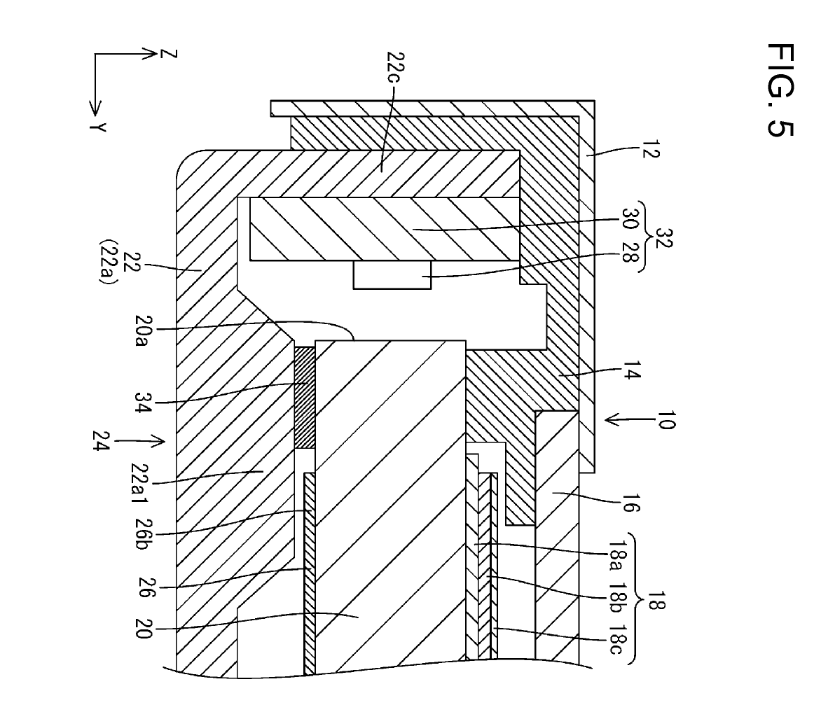

Next, a configuration of the reflective sheet 26, which is a main component of the present embodiment, and a configuration for fixing the end edges of the reflective sheet 26 will be described in detail. FIG. 3 is a plan view of the backlight device 24 from the front. FIG. 4 is a cross-sectional view (of the cross-section of iv-iv in FIG. 4) of the liquid crystal display device 10 in the restricted section 26a of the reflective sheet 26, showing a cross-section configuration cut along the vertical direction (Y-axis direction) of the liquid crystal display device 10. FIG. 5 is a cross-sectional view (of the cross-section of v-v in FIG. 4) of the liquid crystal display device 10 in the free section 26b of the reflective sheet 26, showing a cross-section configuration cut along the vertical direction (Y-axis direction) of the liquid crystal display device 10.

The reflective sheet 26 is a rectangular shape and made of a synthetic resin, and the surface thereof is white with excellent light-reflecting characteristics. The reflective sheet 26 is placed on the front side of the bottom plate 22a of the chassis 22. The reflective sheet 26 has a reflective face on the front side thereof, and this reflective face abuts the opposite plate surface 20c of the light guide plate 20. The reflective sheet 26 can reflect light that has leaked from the LED units 32 or light guide plate 20 towards the light reflecting face of the reflective sheet 26. As shown in FIG. 3, both end edges of the short sides of the reflective sheet 26 and one end edge of the long side thereof slightly protrude out from the end of the light guide plate 20, and the end edge of the other long side has an arrangement and shape that does not reach the end of the light guide plate 20. Of the end edges of the reflective sheet 26, the three sides that slightly protrude out from the ends of the light guide plate 20 are the restricted sections 26a, which are described later, and the side that does not reach the end of the light guide plate 20 is the free section 26b, which is described later.

As shown in FIG. 4, in the restricted section 26a of the reflective sheet 26, the spacer 34 is placed on a portion of the top face of the protruding section 22a1 of the chassis 22, and the restricted section 26a of the reflective sheet 26 is placed above this spacer 34. The restricted section 26a of the reflective sheet 26 is held between the spacer 34 and the light guide plate 20. By being held in this way, the restricted section 26a of the reflective sheet 26 is fixed, and movement in the plate surface direction (the plate surface direction of the bottom plate 22a of the chassis 22/the X-Y planar direction) of the light guide plate 20 is restricted.

As shown in FIG. 5, in the free section 26b of the reflective sheet 26, the spacer is 34 is placed on a portion of the top face of the protruding section 22a1 of the chassis 22, and the light guide plate 20 is placed on this spacer 34. The end edge of the free section 26b of the reflective sheet 26 does not reach the location where the spacer 34 is arranged and abuts the opposite place surface 20c of the light guide plate 20. The spacer 34 (the spacer 34 shown in FIG. 5) arranged in the vicinity of the free section 26b has a slightly greater thickness (specifically, the same thickness as the reflective sheet 26) than the spacer 34 (the spacer 34 shown in FIG. 4) arranged in the vicinity of the restricted section 26a. The rear surface of the free section 26b of the reflective sheet 26 is separated from the protruding section 22a1 of the chassis 22. Therefore, the free section 26b of the reflective sheet 26 is not fixed, and movement in the plate surface direction (the plate surface direction of the bottom plate 22a of the chassis 22/the X-Y planar direction) of the light guide plate 20 is allowed.

As described above, the three sides of the end edges of the reflective sheet 26 are fixed to restrict movement in the plate surface direction of the light guide plate 20, and the remaining one side is not fixed so that movement in the plate surface direction of the light guide plate 20 is allowed. With such a configuration, wrinkles that occur on the reflective sheet 26 can be eliminated from the end thereof at the free section 26b while the reflective sheet 26 is fixed at the restricted sections 26a. In the backlight device 24, the protruding section 22a1 and spacers 34 are provided on the chassis 22, and it is possible to fix the restricted sections 26a by merely holding these restricted sections 26a of the reflective sheet 26 between the respective spacers 34 and the light guide plate 20. As a result, with a simple configuration the free section 26b can be provided on a portion of the end edge of the reflective sheet 26, and the restricted sections 26a can be provided on the other end edges.

In the backlight device 24 according to the present embodiment as described above, wrinkles caused by thermal expansion and contraction of the reflective sheet 26 can be eliminated at the free section 26b while the reflective sheet 26 is fixed at the restricted sections 26a. Therefore, uneven brightness on the display surface of the liquid crystal panel 16 can be prevented or suppressed with a simple configuration and without using a special reflective sheet or the like.

In the backlight device 24 of the present embodiment, a portion of the bottom plate 22a has a protruding section that protrudes towards the light guide plate 20. Thus, in the restricted sections 26a, a portion of the reflective sheet 26 is indirectly held between a portion of the bottom plate 22a and the light guide plate 20.

The backlight device 24 according to the present embodiment has the spacer members 34 arranged between the bottom plate 22a and the light guide plate 20. Thus, in the restricted sections 26a, a portion of the reflective sheet 26 is held between the respective spacer members 34 and the light guide plate 20.

In the backlight device 24 according to the present embodiment, the bottom plate 22a has a rectangular shape, and the reflective sheet 26 has a rectangular shape. The long side direction of the reflective sheet 26 is arranged so as to be along the long side direction of the bottom plate 22a, and the free section 26b is provided on the end edge of the reflective sheet 26 that is arranged on one long side of the bottom plate 22a. The long sides of the reflective sheet 26 are more susceptible than the short sides to being warped during thermal expansion and contraction. Therefore, by providing the free section 26b on the long side of the reflective sheet 26, thermal expansion and contraction of the reflective sheet 26 can be effectively eliminated at the free section 26b.

The backlight device 24 of the present embodiment is further provided with the LED substrates 30 that each have a plurality of the LED light sources 28 arranged on the surface thereof. The LED substrates 30 are arranged along both long side directions of the bottom plate 22a. Thermal expansion and contraction of the reflective sheet 26 is more susceptible to occurring, the closer to the LED light sources 28 the location is. In the backlight device 24, the free section 26b is provided on the LED substrate 30 side of the reflective sheet 26 where thermal expansion and contraction is likely to occur, thus making it possible to effectively eliminate thermal expansion and contraction of the reflective sheet 26 at the free section 26b while realizing a configuration in which the LED substrates 30 are arranged on both long sides of the bottom plate 22a.

### Modification Example of Embodiment 1

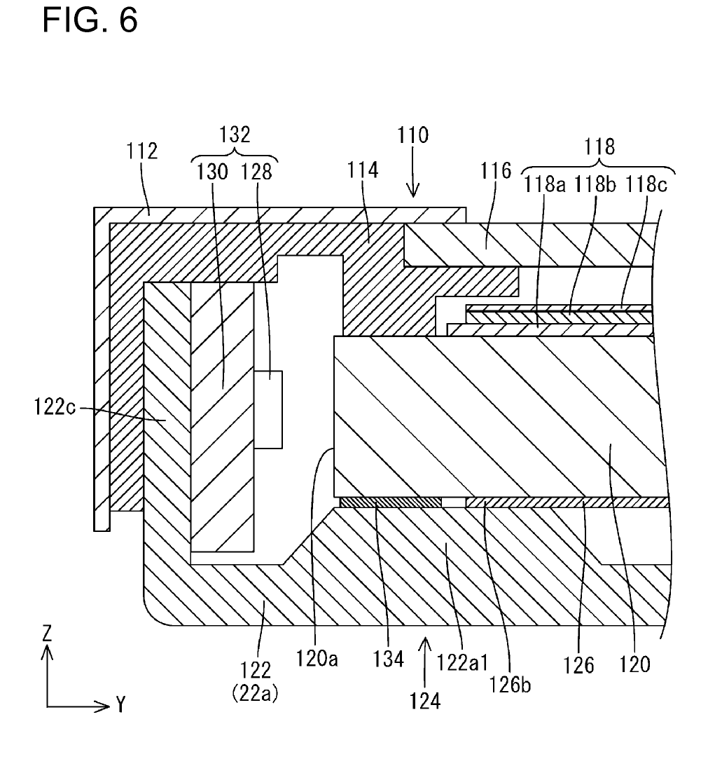

Next, a modification example of Embodiment 1 will be described. FIG. 6 is a cross-sectional view of a liquid crystal display device 110 at a free section 126b of a reflective sheet 126 in a modification example of Embodiment 1. In the modification example, only the thickness of a spacer in the free section differs from Embodiment 1, and other elements are the same as Embodiment 1. In FIG. 6, parts where 100 has been added to reference character from FIG. 4 are the same parts described in Embodiment 1.

As shown in FIG. 6, in the liquid crystal display device 110 of the modification example, the thickness of a spacer 134 arranged in the vicinity of the free section 126b is less than the thickness of the spacer 34 (see FIG. 4) arranged in the vicinity of the free section 26b in Embodiment 1. Specifically, the thickness of the spacer 134 is equal to the thickness of the reflective sheet 126. Therefore, the free section 126b of the modification example is held between a protruding section 122a1 of a chassis 122 and a light guide plate 120, and the force that presses (holds) the end edge of the reflective sheet 126 is stronger than in the free section 26b in Embodiment 1. In FIG. 6, the force exerted towards the protruding section 122a1 from the light guide plate 120 side is transmitted not only to the free section 126b of the reflective sheet 126, but also to the spacer 134, resulting in the free section 126b of the modification example having a force pressing (holding) the end edge of the reflective sheet 126 that is weaker than in the restricted sections. In the modification example, the free section 126b having such a configuration allows the reflective sheet 126 to be fixed at the free section 126b and simultaneously allows the elimination of wrinkles caused by thermal expansion and contraction of the reflective sheet 126.

### Embodiment 2

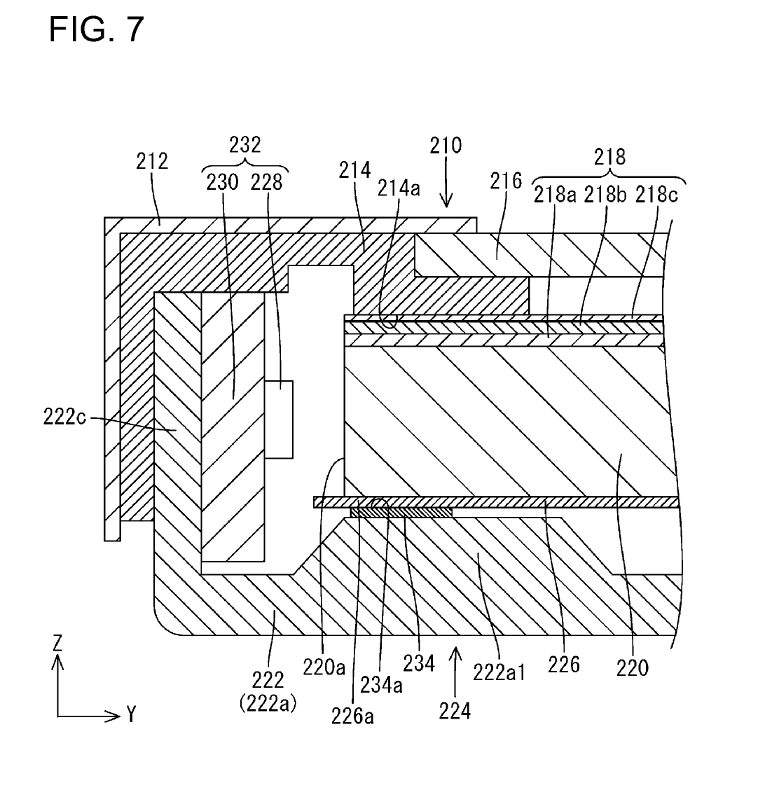

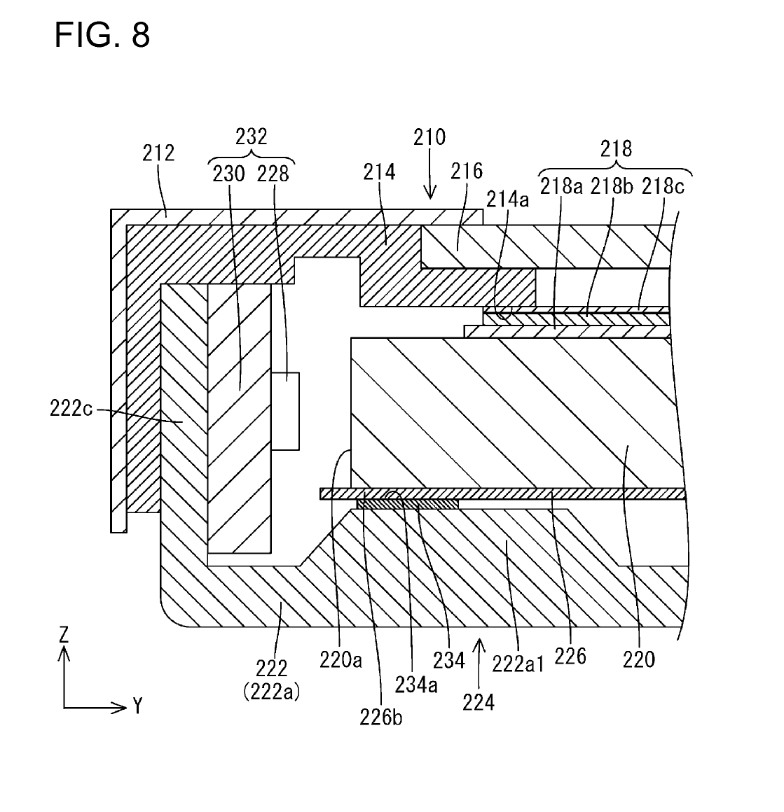

Embodiment 2 will be described with reference to the drawings. FIG. 7 is a cross-sectional view of a liquid crystal display device 210 at a restricted section 226a of a reflective sheet 226 in Embodiment 2. FIG. 8 is a cross-sectional view of the liquid crystal display device 210 at a free section 226b of the reflective sheet 226 in Embodiment 2. The shape of a frame 214 in Embodiment 2 differs from that in Embodiment 1. Other elements are similar to those of Embodiment 1, and therefore, descriptions of the configurations, the operation, and the effect will be omitted. Parts in FIGS. 1 and 8 that have 200 added to the reference characters of FIG. 5 are the same as these parts described in Embodiment 1.

As shown in FIGS. 7 and 8, in the liquid crystal display device 210 of Embodiment 2, the restricted section 226a and free section 226b have equal configurations at the end edges of the reflective sheet 226, and not just the restricted section 226a but also the free section 226b is held between a spacer 234 and the light guide plate 220. A portion of an end edge of the frame 214 abuts the surface of optical sheets 218. As shown in FIG. 7, in the vicinity of the restricted section 226a, the optical sheets 218 extend to the end of the light guide plate 210, and a portion of an abutting surface 214a between the frame 214 and the optical sheets 218 overlaps an abutting surface 234a of the reflective sheet 226 and the spacer 234 in the thickness direction (the Z-axis direction) of the light guide plate 220. As shown in FIG. 8, however, in the vicinity of the free section 226b, the optical sheets 218 do not extend to the end of the light guide plate 210, and the abutting surface 214a between the frame 214 and the optical sheets 218 do not overlap the abutting surface 234a between the reflective sheet 226 and the spacer 234 in the thickness direction (the Z-axis direction) of the light guide plate 220.

With such as configuration as described above, in the restricted section 226a force is applied from the frame 214 side towards the light guide plate 220 directly above the abutting surface 234a between the reflective sheet 226 and the spacer 234, whereas in the free section 226b force is applied from the frame 214 side towards the light guide plate 220 at a location shifted to the abutting surface 234a between the reflective sheet 226 and the spacer 234 in the plate surface direction (the X-Y planar direction) of the light guide plate 220. Thus, in the free section 226b, the force that presses (holds) the end edge of the reflective sheet 226 is weaker than in the restricted section 226a. In Embodiment 2, having such a configuration allows the reflective sheet 226 to be fixed at the free section 226b and simultaneously allows the elimination of wrinkles caused by thermal expansion and contraction of the reflective sheet 226.

### Embodiment 3

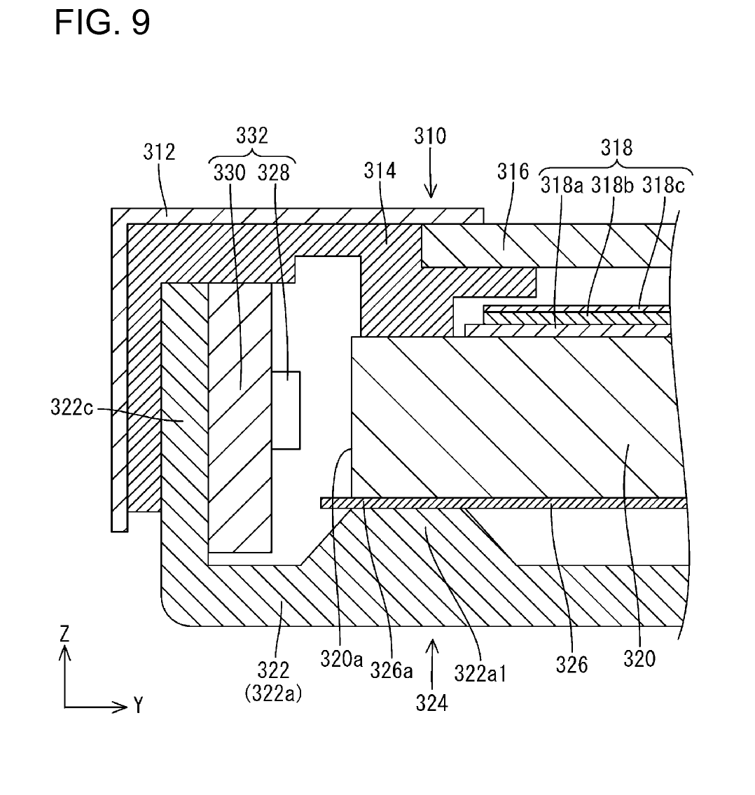

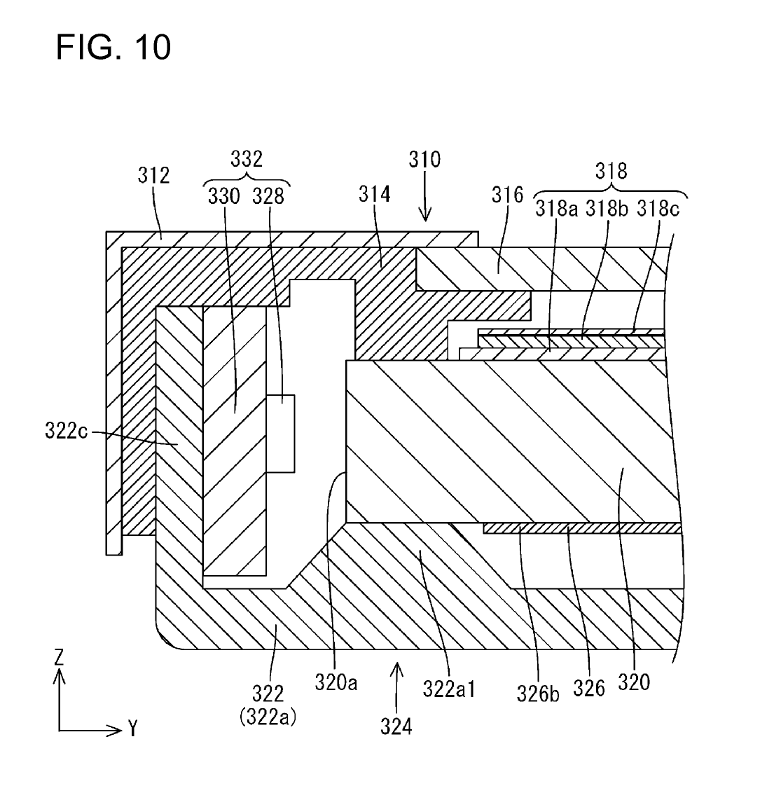

Embodiment 3 will be described with reference to the drawings. FIG. 9 is a cross-sectional view of a liquid crystal display device 310 at a restricted section 326a of a reflective sheet 326 in Embodiment 3. FIG. 10 is a cross-sectional view of the liquid crystal display device 310 at a free section 326b of the reflective sheet 326 in Embodiment 3. Embodiment 3 differs from Embodiment 1 in that there are no spacers. Other elements are similar to those of Embodiment 1, and therefore, descriptions of the configurations, the operation, and the effect will be omitted. Parts in FIGS. 9 and 10 that have 300 added to the reference characters of FIGS. 4 and 5 are the same as these parts described in Embodiment 1.

The liquid crystal display device 310 according to Embodiment 3 does not have spacers, and as shown in FIGS. 9 and 10, spacers are not arranged on the surface of a protruding section 322a1 of a chassis 322. Therefore, as shown in FIG. 9, of the end edges of the reflective sheet 326, the restricted section 326a is fixed at the restricted section 326a by being held between the protruding section 322a1 of the chassis 322 and a light guide plate 320. In the free section 326b, the end edge of the reflective sheet 326 does not extend to the end of the light guide plate 320, the top surface of the protruding section 322a1 abuts the opposite plate surface of the light guide plate 320, and the free section 326b merely abuts the opposite plate surface of the light guide plate 320 and is therefore is not held between the protruding section 322a1 and the light guide plate 320. Even if the spacers are not provided as such, wrinkles caused by thermal expansion and contraction of the reflective sheet 326 can be eliminated at the free section 326b while the reflective sheet 326 is fixed at the restricted sections 326a. As a result, uneven brightness on the display surface of a liquid crystal panel 316 can be prevented or suppressed with a simple configuration.

### Embodiment 4

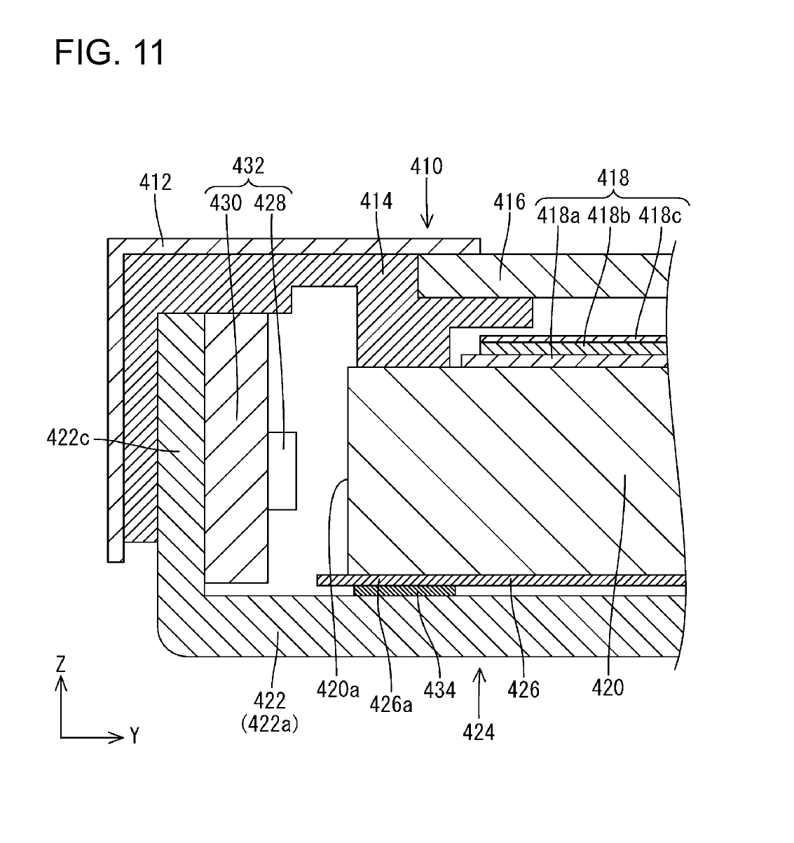

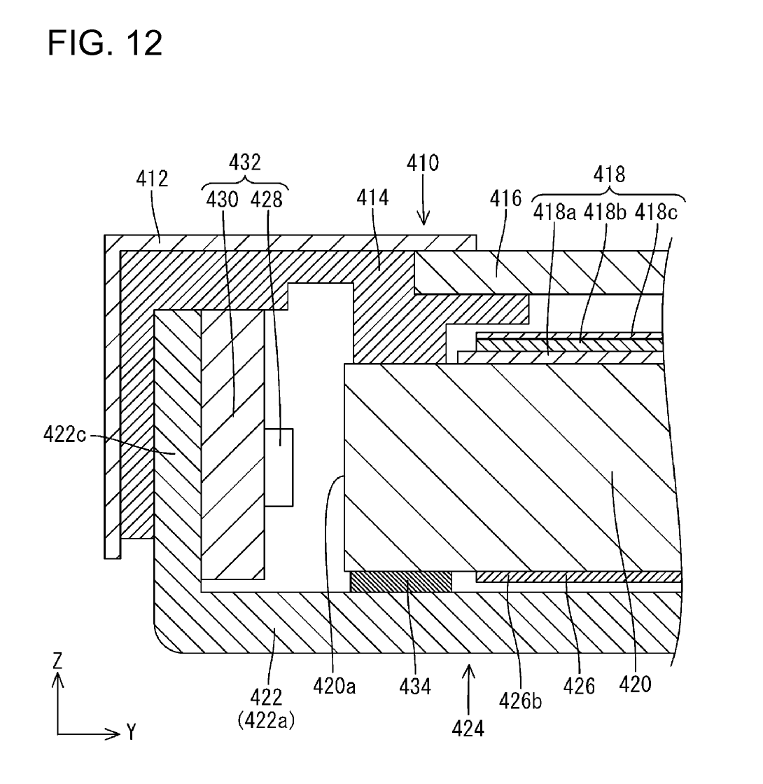

Embodiment 4 will be described with reference to the drawings. FIG. 11 is a cross-sectional view of the liquid crystal display device 410 at a restricted section 426a of a reflective sheet 426 in Embodiment 4. FIG. 12 is a cross-sectional view of the liquid crystal display device 410 at a free section 426b of the reflective sheet 426 in Embodiment 4. Embodiment 4 differs from Embodiment 1 in that a protruding section is not provided on a chassis 422. Other elements are similar to those of Embodiment 1, and therefore, descriptions of the configurations, the operation, and the effect will be omitted. Parts in FIGS. 11 and 12 that have 400 added to the reference characters of FIGS. 4 and 5 are the same as these parts described in Embodiment 1.

As shown in FIGS. 11 and 12, the liquid crystal display device 410 of Embodiment 4 does not have a protruding section on a bottom plate 422a of the chassis 422, and a spacer 434 is arranged on a portion above the bottom plate 422a of the chassis 422. In a similar manner to Embodiment 1, the restricted section 426a of the reflective sheet 426 is held between the spacer 434 and a light guide plate 420, the surface of the free section 426b of the reflective sheet 426 abuts the opposite plate surface of the light guide plate 420, and the rear surface of the free section 426b is separated from the bottom plate 422a of the chassis 422. Even if the protruding section is not provided on the chassis 422 as such, wrinkles caused by thermal expansion and contraction of the reflective sheet 426 can be eliminated at the free section 426b while the reflective sheet 426 is fixed at the restricted sections 426a. As a result, uneven brightness on the display surface of a liquid crystal panel 416 can be prevented or suppressed with a simple configuration.

### Embodiment 5

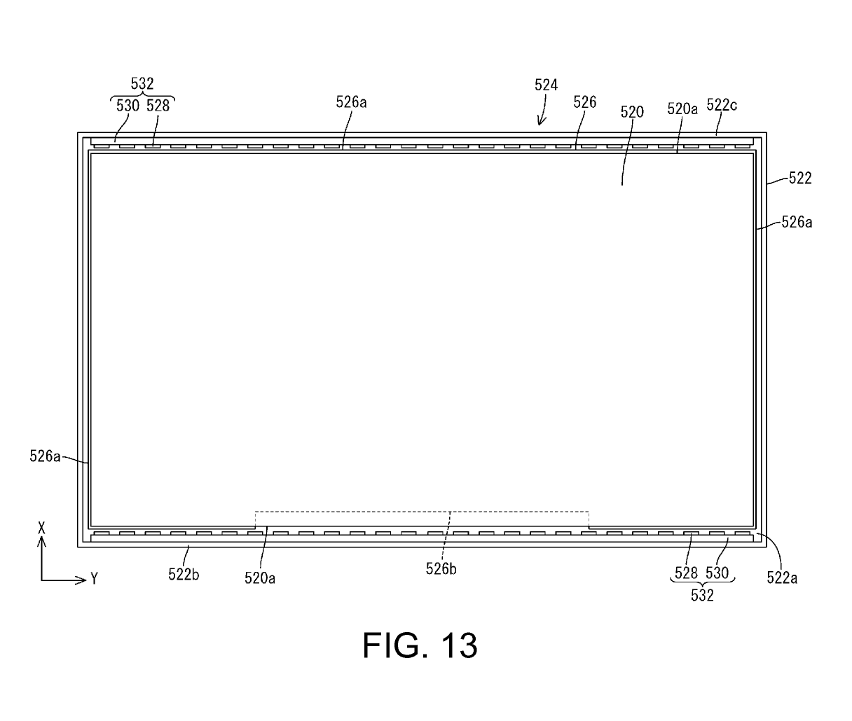

Embodiment 5 will be described with reference to the drawings. FIG. 13 is a plan view of a backlight device 524 of Embodiment 5. The arrangement of a restricted section and free section of a reflective sheet in Embodiment 5 is similar to Embodiment 1, and therefore, descriptions of the configurations, the operation, and the effect will be omitted. Parts in FIG. 13 that have 500 added to the reference characters of FIG. 3 are the same as these parts described in Embodiment 1.

As shown in FIG. 13, the backlight device 524 of Embodiment 5 has restricted sections 526a on both short sides and one long side of the end edges of a reflective sheet 526, in a similar manner to Embodiment 1. On the other long side of the reflective sheet 526 (the long side on the bottom in FIG. 13) the restricted section 526a and a free section 526b are arranged together. Specifically, on the other long side, both end sides are restricted sections 522a that extend more towards a side plate 522b than the end of the light guide plate 520, and the middle of this other long side is the free section 526b that does not extend to the end of the light guide plate 520. With such a configuration, on the other long side, the middle is not fixed so that movement in the plate surface direction of the light guide plate 520 is allowed while both end sides are fixed so that movement in the plate surface direction of the light guide plate 520 is restricted. Even with such a configuration, wrinkles that occur on the reflective sheet 526 can be eliminated at the middle of this other long side while the reflective sheet 526 is fixed at both short sides and one long side of the reflective sheet 526 and at both end sides of the other long side of the reflective sheet 526.

### Embodiment 6

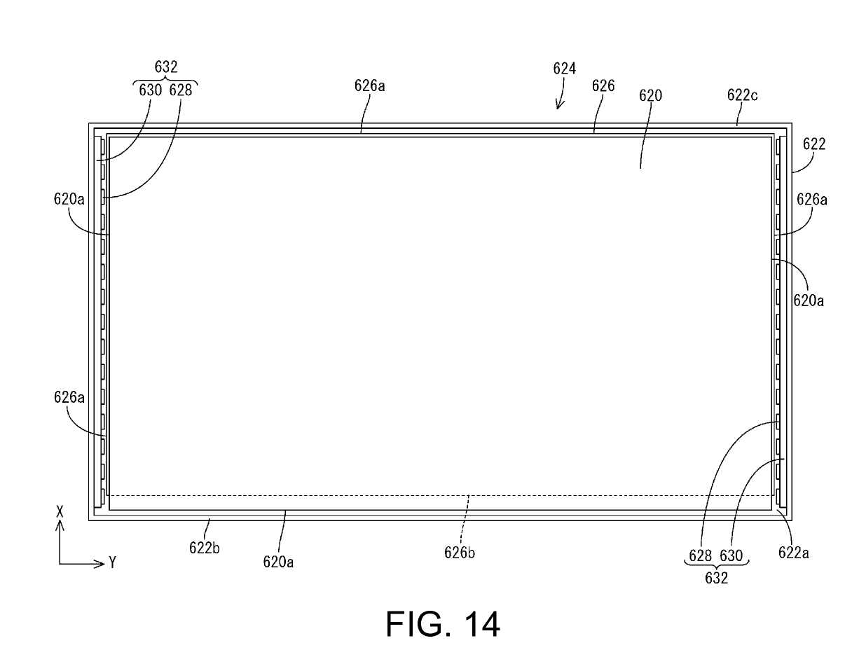

Embodiment 6 will be described with reference to the drawings. FIG. 14 is a plan view of a backlight device 624 of Embodiment 6. Embodiment 6 differs from Embodiment 1 in the arrangement of LED units 632 in a chassis 622. Other elements are similar to those of Embodiment 1, and therefore, descriptions of the configurations, the operation, and the effect will be omitted. Parts in FIG. 14 that have 600 added to the reference characters of FIG. 3 are the same as these parts described in Embodiment 1.

As shown in FIG. 14, the backlight device 624 of Embodiment 6 has a pair of LED units 632 and 632 that each extend in the short side direction of the chassis 622, and each LED unit 632 and 632 respectively abuts the inside of the side plate on each short side of the chassis 622. The arrangement of a restricted section 626a and free section 626b of the reflective sheet 626 in the chassis 622 is similar to Embodiment 1. Even with such a configuration, wrinkles that occur on the reflective sheet 626 can be eliminated at the free section 626b arranged on the other long side of the reflective sheet 626 while the reflective sheet 626 is fixed at the restricted sections 626a arranged on both short sides and one long side of the reflective sheet 626.

### Embodiment 7

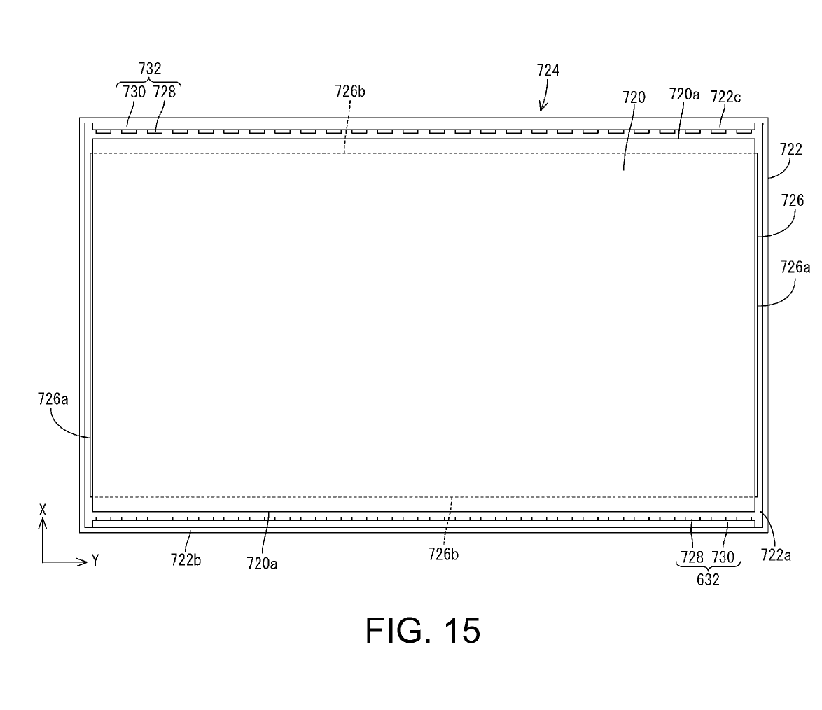

Embodiment 7 will be described with reference to the drawings. FIG. 15 is a plan view of a backlight device 724 of Embodiment 7 from the front. Embodiment 7 differs from Embodiment 1 in the arrangement of restricted sections 726a and free sections 726b of a reflective sheet 726. Other elements are similar to those of Embodiment 1, and therefore, descriptions of the configurations, the operation, and the effect will be omitted. Parts in FIG. 15 that have 700 added to the reference characters of FIG. 3 are the same as these parts described in Embodiment 1.

As shown in FIG. 15, in the backlight device 724 of Embodiment 7, both short sides of the end edges of the reflective sheet 726 are the restricted sections 726a, and both long sides are the free sections 726b. Accordingly, in the backlight device 724, the extent of the free sections 726b is greater than the configuration in Embodiment 1, and wrinkles that occur on the reflective sheet 726 can be effectively eliminated at the free sections 726b.

The corresponding relation between the configurations of each embodiment and the configurations of the present invention will be described. The bottom plates (of the chassis) 22a, 122a, 222a, 322a, 422a, 522a, 622a, and 722a are examples of “plate-shaped portions.” The LED light sources 28, 128, 228, 328, 428, 528, 628, and 728 are examples of “light sources.” The protruding sections 22a1, 122a1, 222a1, 322a1, 422a1, 522a1, 622a1, 722a1 and/or the spacers 34, 134, 234, 334, 434, 534, 634, 734 are examples of “protruding parts.” The backlight devices 24, 124, 224, 324, 424, 524, 624, and 724 are examples of “illumination devices.” The spacers 34, 134, 234, 334, 434, 534, 634, and 734 are examples of “spacer members.” The frames 14, 114, 214, 314, 414, 514, 614, and 714 are examples of “frame members.” The LED substrates 30, 130, 230, 330, 430, 530, 630, and 730 are examples of “light source substrates.” The liquid crystal display devices 10, 110, 210, 310, 410, 510, 610, and 710 are examples of “display devices.”

Modification examples of the respective embodiments above will be described below. (1) In the respective embodiments above, a configuration was illustratively shown in which a backlight device has at least a protruding section or a spacer, but both may be omitted. In this case, a protruding part may be provided, and a configuration may be adopted in which the reflective sheet is fixed at restricted sections of the reflective sheet by the light guide plate and protruding part, and not fixed at a free section of the reflective sheet.

(2) In the respective embodiments above, a configuration was illustratively shown in which LED units are arranged on both long sides or both short sides, but the arrangement of the LED units in the chassis is not limited thereto. In this case, the arrangement of the restricted section and free section of the reflective sheet may be determined in accordance with the arrangement of the LED units.

(3) In addition to the respective embodiments above, an aspect for restricting movement of the reflective sheet in the plate surface direction of the light guide plate at the restricted sections of the reflective sheet can be modified as appropriate.

(4) In addition to the respective embodiments above, an aspect for allowing movement of the reflective sheet in the plate surface direction of the light guide plate at the free section of the reflective sheet can be modified as appropriate.

(5) In addition to the respective embodiments above, the arrangement of where the restricted sections and free section are provided on the end edges of the reflective sheet can be modified as appropriate.

(6) In the respective embodiments above, a liquid crystal display device using a liquid crystal panel as a display panel was illustratively shown, but the present invention is also applicable to a display device that uses another type of display panel.

(7) In the respective embodiments above, a television receiver that includes a tuner was illustratively shown, but the present invention is also applicable to a display device without a tuner.

Embodiments of the present invention were described above in detail, but these are merely examples, and do not limit the scope defined by the claims. The technical scope defined by the claims includes various modifications of the specific examples described above.

Also, the technical elements described in the present specification or shown in the drawings realize technical utility each on their own or through a combination of various technical elements, and are not limited to the combinations defined by the claims at the time of filing. Also, the techniques described in the present specification or shown in the drawings can accomplish a plurality of objects simultaneously, and each one of the objects on its own has technical utility.

### DESCRIPTION OF REFERENCE CHARACTERS

TV television receiver

Ca, Cb cabinet

T tuner

S stand

10, 110, 210, 310, 410 liquid crystal display device

12, 112, 212, 312, 412 bezel

14, 114, 214, 314, 414 frame

16, 116, 216, 316, 416 liquid crystal panel

18, 118, 218, 318, 418 optical member

20, 120, 220, 320, 420, 520, 620, 720 light guide plate

20a, 120a, 220a, 320a, 420a, 520a, 620a, 720a light-receiving face

22, 122, 222, 322, 422, 522, 622, 722 chassis

22a1, 122a1, 222a1, 322a1, 422a1 protruding section

24, 124, 224, 324, 424, 524, 624, 724 backlight device

26, 126, 226, 326, 426, 526, 626, 726 reflective sheet

26a, 126a, 226a, 326a, 426a, 526a, 626a, 726a restricted section

26b, 126b, 226b, 326b, 426b, 526b, 626b, 726b free section

28, 128, 228, 328, 428, 528, 628, 728 LED light source

30, 130, 230, 330, 430, 530, 630, 730 LED substrate

32, 132, 232, 332, 432, 532, 632, 732 LED unit

34, 134, 234, 334, 434 spacer

1. An illumination device, comprising:
a chassis having at least a plate-shaped portion that is rectangular in a plan view;
a light guide plate that has a light-receiving surface as a side face and that has a plate surface opposing a surface of the plate-shaped portion;
a light source that is arranged on the surface of the plate-shaped portion and that faces the light-receiving surface;
a protruding part that is located on the surface of the plate-shaped portion and that protrudes towards the light guide plate; and
a reflective sheet that is arranged between the light guide plate and the plate-shaped portion and that has a portion of an end edge as a free section that is free to move in a plate surface direction of the light guide plate and that has another end edge as a restricted section that is restricted in movement in the plate surface direction of the light guide plate by being held between the protruding part and the light guide plate.

2. The illumination device according to claim 1, wherein the protruding part includes a protruding section where a portion of the plate-shaped portion protrudes towards the light guide plate.

3. The illumination device according to claim 1, wherein the protruding part includes a spacer member arranged between the plate-shaped portion and the light guide plate.

4. The illumination device according to claim 3, wherein a thickness of the spacer member is equal to a thickness of the reflective sheet.

5. The illumination device according to claim 1, further comprising:
an optical member that is rectangular in a plan view and that is arranged above another plate surface of the light guide plate; and
a frame member arranged above an end edge of the optical member,
wherein an abutting face between the frame member and the optical member overlaps an abutting face between the protruding part and the reflective sheet of the restricted section in a thickness direction of the light guide plate and does not overlap an abutting face between the protruding part and the reflective sheet of the free section in the thickness direction of the light guide plate.

6. The illumination device according to claim 1,
wherein the plate-shaped portion is rectangular,
wherein the reflective sheet is rectangular and a long side thereof is arranged along a long side of the plate-shaped portion, and
wherein the free section is provided on an end edge of the reflective sheet that is arranged on one long side of the plate-shaped portion.

7. The illumination device according to claim 6, further comprising:
a light source substrate having a plurality of the light sources arranged on a plate surface thereof,
wherein the light source substrate is arranged along both long side directions of the plate-shaped portion.

8. The illumination device according to claim 1, wherein the restricted section and the free section are arranged together on a side of the reflective sheet.

9. A display device, comprising a display panel that uses light from the illumination device according to claim 1 to perform display.

10. The display device according to claim 9, wherein the display panel is a liquid crystal panel that uses liquid crystal.

11. A television receiver, comprising the display device according to claim 9.
